(19) United States
(12) Patent Application Publication
(10) Pub. No.: US 2006/0041522 A1
(43) Pub. Date: Feb. 23, 2006

(54) Abstract document management systems and methods

(75) Inventor: David R. Rodriguez-Rivera, Macedon, NY (US)

Correspondence Address: ORTIZ & LOPEZ, PLLC;Patent Attorneys, P.O. Box 4484, Albuquerque, NM, 87196-4484, US

(73) Assignee: Xerox Corporation.

(21) Appl. No.: 10/920,884

(22) Filed: Aug. 18, 2004

(51) Int. Cl. G06F 17/00

(52) U.S. Cl. 707/1

(57) ABSTRACT

An abstract document management layer service (ADML service/module) operating as a single service enabling retrieval, manipulation and management of documents using various specifications. Documents are accessed from a single point of entry. Multiple-document management systems virtually integratale behind ADML. ADML is accessible over a network-enabled interface and provides document access using specification like JAVA, C, CORBA. ADML is Web accessible using JAVA servlet technology. Service requests can be based on HTTP, and ADML responses can be carried out using XML. Access to the contents of a document is URL-based. URLs enable a client application to download documents without additional interaction. URLs can be stored outside of ADML and used to access a specific document. Users can search for a document across repositories based on criteria, retrieve a document, create a document, commit document changes, request additional meta-data, freezes document content prevent changes/deletion, change document states to support workflow, and sets meta-data.

### FIELD OF THE INVENTION

The invention is generally related to document retrieval, manipulation and management using a single service. More particular, the present invention is directed to an abstract document management layer operating as a single service (“ADML service”) to enable seamless retrieval, manipulation and management of documents from more than one document management repository having different document definitions (“diverse documents”) and, furthermore, to enable diverse document interaction over a network-based interface.

### BACKGROUND

Current approaches for integrating applications and document management systems (DMS) require both DMS vendors and software application vendors to write applications to a well-defined open standard interface. Although such an architecture should enable smooth integration between applications and document management systems, it requires a commitment from document management systems vendors to support the standard application programming interface (API). Furthermore, current architectures require installation of a client service in desktops so that users can operate document management systems. In some cases, very complex client/server architectures must be established in order to enable communications between applications and document management systems.

What is apparently needed in the art is a single document management service that enables users to retrieve, manipulate and manage diverse documents (e.g., documents from repositories with different standards or specifications) using a single interface. It is further desirable and needed that such interface be enabled for such functions over a web-browser.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

The present invention is directed to an abstract document management layer (ADML) operating as a single service to enable the retrieval, manipulation and management of documents from more than one document management repositories with different definitions by normalizing the document definition at the ADML level.

It is accordingly, a feature of the present invention to provide an abstract document management layer (ADML) as a service (ADML service) that enables sharing of documents that are distributed across different document management repositories.

It is another feature of the present invention that the ADML service will allow system users independent access to documents from a single point of entry.

It is a feature of the present invention to provide an ADML service that enables systems with the ability to virtually integrate multiple document management systems behind a single service.

It is a feature of the present invention to provide a technology independent specification so that the interface can be enabled trough any application interface including services over the web.

It is yet another feature of the present Interfaces can be written in computer programming languages such as Java, C, C++, and be exposed trough interfaces such as Java RMI, Web Services, CORBA, Servlets, XML, etc.

It is a feature of the present invention to provide at least most of the following functions: Search for a document across repositories based on criteria, Retrieve a document, Create a document, Checkout a document for modification, Commit document changes, Request additional meta-data, Freezes document content to prevent changes/deletion, Changes document state to support workflow, and Sets meta-data.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a diagram of the ADML solution with a web interface and API interfaces in accordance with aspects of the present invention.

FIG. 2 shows a network architecture for deployment of the ADML system is illustrated.

FIG. 3 illustrated a hierarchy search tree that can be utilized by the present invention for document searching.

FIG. 4 illustrates a threading mechanism to reduce the execution time to search for documents.

### DETAILED DESCRIPTION OF PREFERRED EMBODIMENTS

The particular values and configurations discussed in these non-limiting examples can be varied and are cited merely to illustrate at least one embodiment and are not intended to limit the scope of the invention.

An abstract document management service in the form of an abstract document management layer (“ADML service”) has been created to support system independent document management. The ADML service enables sharing of documents that are typically distributed across different document management repositories. ADML service will allow system independent access to documents from one single point of entry.

The features illustrated in the following table are provided by ADML service:

| Service Call | Service Description |
|---|---|
| ADML_Select | Search for a document across repositories based |
| | on a given criteria. |
| ADML_Open | Retrieve a document |
| ADML_New | Create a document |
| ADML_Checkout | Checkout a document for modification |
| ADML_Checkin | Commit document changes |
| ADML_GetProperties | Request additional meta-data |
| ADML_Freeze | Freezes the content of the document to prevent |
| | changes/deletion |
| ADML_Promote | Changes the state of document to support |
| | workflow |
| ADML_SetProperties | Sets meta-data |

The services can be made available to other applications using by different data exchange technologies including: Web technology involving HTTP, XML and servlets. This option can be referred to herein as ADML-HTTP service. ADML will support a normalized document object for searching and retrieval of document meta-data. It is another feature of the present invention that the ADML service be available through a web service using JAVA servlet technology. Service requests using this interface will be based on the Hyper Text Transfer Protocol (HTTP) and ADML responses will be eXtensible Markup Language (XML). Access to the contents of a document will be based on Universal Resource Locators (URLs). URLs will allow a client application to download the document without any additional interaction. URLs can be stored outside of ADML and used to access a specific document.

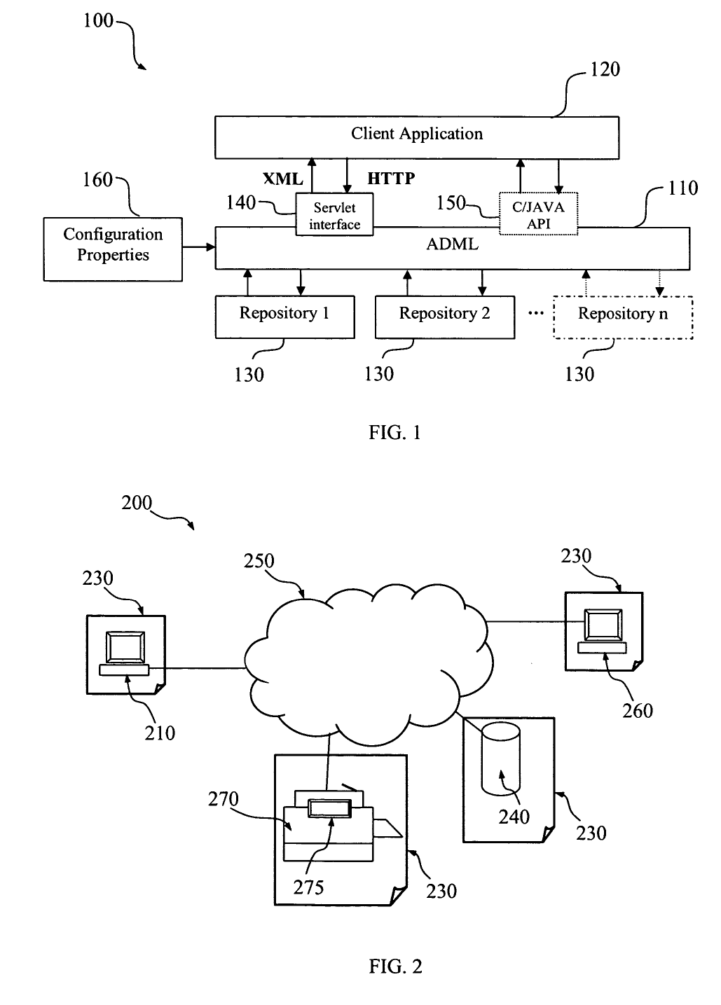

Referring to FIG. 1, a diagram of the ADML service architecture 100 is shown. The ADML service architecture 100 includes an ADML application layer 110 operating under a client application layer 120. Configuration properties are accessible by the ADML layer 110, which enable the ADML layer 110 to interpret and diverse documents retrieved from repositories 130 over which the ADML layer 110 is granted access. Access is based on user authorization and authentication procedures well known in the art, which can typically be set up using configuration properties 160. A network (e.g., Web) interface 140 and API interfaces 150 complete the ADML service architecture 100 as shown.

Referring to FIG. 2, a network architecture for deployment of the ADML system is illustrated. In a network environment 200, clients 210, servers 260, printing devices 270 and databases 240 can exchange and manage abstract documents 230 over networks 250 using the ADML system shown in FIG. 1. Documents are managed utilizing User Interfaces 275 similar to that shown in association with the printer 270. The abstract documents 230 shown associated with each hardware component also represent the ADML solution.

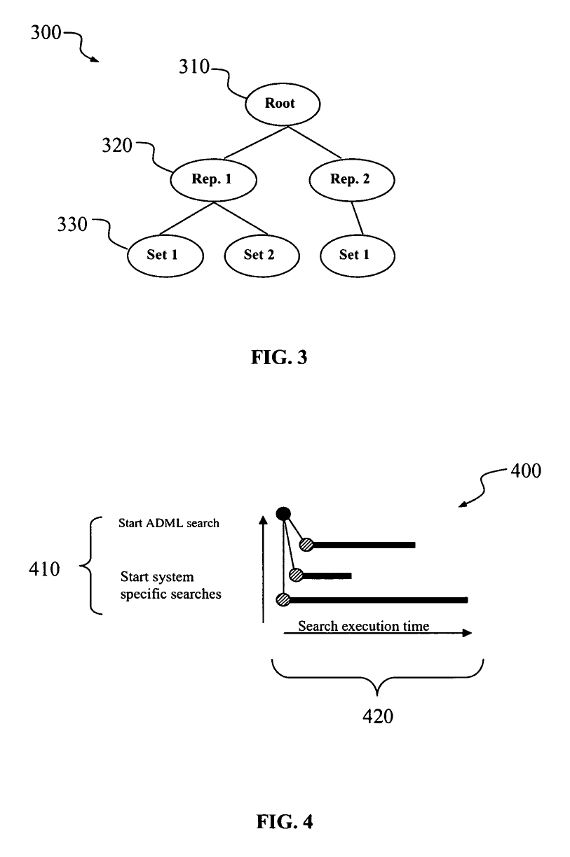

Besides the relation to document management with respect to the services, the ADML service has also a relation with Lightweight Directory Access Protocol (“LDAP”) with respect to its searching capabilities. The search engine is based on a hierarchical mechanism where the client applications can either search at the root level, if the location of the document object is unknown, or can be limited to a certain branch or set of branches if more location information is available. Referring to FIG. 3, the concept of a hierarchy search tree 300 employed by the present invention is illustrated in a diagram. A Root 310 is the highest level in the search tree 300 for ADML. A set or scope 320 refers to a specific subset of documents in a certain system, such as vaults or collections. A repository 330 refers to a document sharing site. As an example using the diagram 300, one could search all systems, e.g., Repository 1 and Repository 2, if the root 310 is the starting point. The Repositories 1, 2 can represent be typical document management systems, and the sets 320 can represent vault or collections depending on the type of repository 330 accessed. Or one could restrict the search to only Rep 1.

ADML Select and ADML Open have the highest priority. Therefore these services should be implemented prior to any other services. The ADML_Document can be defined as a generic document within the ADML system. It will map the appropriate attributes from the system specific document or file objects. ADML_Document objects will be used to access and manage documents/file objects in the repositories. The mapping between the ADML_Document attributes and the attributes in the document classes from the repository systems will be defined in the configuration file.

The following attributes are defined in the ADML_Document normalized definition:

| Attribute name | Type | Purpose |
|---|---|---|
| filename | Text | Name of the file |
| title | Text | Document's name |
| summary | Text | Document's summary |
| description | Text | Document's description |
| keywords | Text | Set words that more or less hint the content of |
| | | the document. |
| masterHandle | Text | Unique id shared by all versions of the same |
| | | document. |
| creationDate | Date | Date it was created (YYY-MM-DD, e.g., |
| | | 2000-03-15) |
| modifiedDate | Date | Date it was modified (YYY-MM-DD, e.g., |
| | | 2000-03-15) |
| modifiedBy | Text | Modifier's user id (from repository system). |
| createdBy | Text | Creator's user id (from repository system) |
| version | Text | Document's version |
| lockedBy | Text | Id of the user who locked the document. |
| parent | Text | ADML Directory that contains the document |
| id | Text | Unique id of the document |
| locked | Boolean | Flag to show if the document is locked |
| frozen | Boolean | Flag to show if the document is frozen |
| project | Text | Project where the document belongs. |
| state | Text | Current state of the document. |
| mimeType | Text | The document's contents format (i.e., text/html, |
| | | application/MS Word, etc.) |
| category | Text | Document's classification (i.e., Meeting |
| | | Minutes, Requirements, Specifications, etc.) |

The ADML_configuration will provide the ADML service with repository connectivity information and system specific attribute maps. ADML provides a normalized form of a document object (e.g., referring to the meta-data not the actual contents of the document) to allow system independent document management services. ADML will translate queries from this normalized form to a system specific form. This translation will be based on attribute maps. On the other hand, responses from ADML will translate system specific attributes to the normalized form in ADML responses.

Some of the attributes in the ADML_Document can be mapped to attributes in, for example, the Xerox Docushare™ Document class of documents. Docushare™ is a trademark of Xerox Corporation. A map to a specific attribute means that the value of the attribute in the Docushare document will be the same as in the mapped attribute in the ADML_Document object. A DocuShare™ document handle will always point to the latest version. That is why the identification and the masterHandle both map to the handle attribute. The following table lists mapping between ADML and Docushare™:

| ADML | Docushare ™ |
|---|---|
| filename | Document.File |
| title | title |
| summary | summary |
| description | description |
| keywords | keywords |
| masterHandle | handle |
| creationDate | created_date |
| modifiedDate | modified_date |
| modifiedBy | modified_by |
| createdBy | owner |
| version | NOT MAPPED |
| lockedBy | lock.File |
| parent | parent |
| id | handle |
| locked | lockedBy != null |
| frozen | NOT MAPPED |
| project | NOT MAPPED |
| state | NOT MAPPED |
| mimeType | content_type |
| category | NOT MAPPED |

Some of the attributes in the ADML_Document can be mapped to attributes in the Teamcenter Enterprise Solution for the File class including Xerox-customized attributes, which are listed in the following table as custom attributes beginning with “x3.” Teamcenter Enterprise is a software solution distributed by UGS Corp. A map to a specific attribute means that the value of the attribute in the Teamcenter Enterprise File object will be the same as in the mapped attribute in the ADML_Document object. Empty fields mean that the attribute is not mapped.

The Teamcenter Enterprise attribute name are the real attribute names in the File class and not necessary the displayed name. The following table illustrated mapping between ADML and Teamcenter Enterprise attribute names. The filename attribute is shown as mapped to two attributes, the WorkingRelativePath and PathTail. The filename attribute is mapped to the value of the PathTail attribute, but because the PathTail attribute is dynamic, it cannot be used for queries. In the case of queries to Teamcenter Enterprise repositories, using the ADML service it will use the WorkingRelativePath to search for filenames.

| ADML | Teamcenter Enterprise |
|---|---|
| filename | WorkingRelativePath/PathTail |
| title | DataItemDesc |
| summary | NOT MAPPED |
| description | DataItemDesc |
| keywords | x3Notes |
| masterHandle | x3MasterHandle |
| creationDate | CreationDate |
| modifiedDate | LastUpdate |
| modifiedBy | x3Modifier |
| createdBy | Creator |
| version | Sequence |
| lockedBy | CheckOutOwner |
| parent | OwnerName |
| id | OBID |
| locked | SupersededByCkiCko |
| frozen | Frozen |
| project | ProjectName |
| state | LifeCycleState |
| mimeType | MIMEType |
| category | x3DataItemType |

Referring to FIG. 4, ADML can use a threading mechanism 400 to reduce the execution time to search for documents. In order to reduce the execution time with respect to searching ADML must implement a threaded query model for the select service call. The main purpose of these threads is to start searches across multiple directories (read systems) simultaneously. This means that the maximum time 420 to execute a search should be more or less equal to the maximum individual search on a specific directory (Teamcenter Enterprise environment or DocuShare site) and not the sum of all the execution times.

Each system has its own logical name and configuration entries. ADML requires a configuration file, as shown in FIG. 1, to initialize the services. This file will contain the information to allow ADML to access the specified repositories. The following is the format that the configuration file used during testing required:
Entry Format:
(logical_name|system_type) “.” key “=” value
Where:
logical_name=<name of a specific repository system defined in the ADML configuration.>
system_type=<Certain kind of repository system defined in the ADML configuration. For example, “Teamcenter Enterprise” or “Docushare”.>
key=<configuration entry name>
value=<configuration entry value>

The following is a description of configuration file sections utilized with ADML normalized list of attributes and further defines the attributes available in ADML.
Entry format:
“ADML.attribute”<n>“=” value
Where n starts at 0 and have one unit increment for next value.

Example:
ADML.attribute0=filename
ADML.attribute1=title
ADML.attribute2=summary
ADML.attribute3=description
ADML.attribute4=keywords
ADML.attribute5=masterHandle
ADML.attribute6=creationDate
ADML.attribute7=modifiedDate
ADML.attribute8=modifiedBy

The following lists and defines directory drivers available using ADML services in accordance with features of the present invention.
Entry format:
“driver”<n>“=”value (value=driver name)
value“.class=”value (value=fully qualified Java class name)
Where n starts at 0 and have one unit increment for next value.
Example:
driver0=DocuShare
DocuShare.class=xerox.cec.adml.ADML_DocuShareDirectory
driver1=Teamcenter Enterprise
Teamcenter Enterprise.class=xerox.cec.adml.ADML_Teamcenter EnterpriseDirectory

Directory specific attribute mappings associated with the present invention are listed as follows:
Entry format:
driver_name“.”adml_ttribute“=”value
Where driver_name is the driver name specified in the directory drivers' section and adml_attribute is one of the attributes defined the ADML normalized list of attributes; value is the directory specific attribute name.
Example:
DocuShare.filename=document.File
DocuShare.title=title
DocuShare.summary=summary
DocuShare.description=description
Teamcenter Enterprise.filename=WorkingRelativePath
Teamcenter Enterprise.title=DataItemDesc
Teamcenter Enterprise.description=DataItemDesc
Teamcenter Enterprise.keywords=x3Notes

“Directories definitions” define directory logical names and type and connectivity data. This is further illustrated by the following:
Entry format:
logical_name“.type=” value (value=driver name)
logical_name“.host=” value (value=fully qualified hostname)
logical_name“.port=” value (value=port if no default port used)
logical_name“.username=”value (value=directory specific username)
logical_name“.password=”value (value=user's password if required)
Where:
logical_name=User friendly name to be used to identify a specific directory.
host=<host name of the server where the repository system resides>
port=<port number that the repository listens>; Some directories use standard protocol ports, however other use custom defined ports, it really depends on how the system is defined. If no port is specified the directory should use a standard port to connect. Some directories require an explicit definition of port, e.g., Teamcenter Enterprise.
username=<valid user id in the repository system>; Some directories have a default user that can used if none specified, in the other hand some require an explicit username and password.
password=<valid password associated with the user id>
Example:
amberweb.type=DocuShare
amberweb.host=amberweb.wrc.xerox.com
techweb.type=DocuShare
techweb.host=techweb.wrc.xerox.com
tiptup.type=DocuShare
tiptup.host=tiptup.engsys.mc.xerox.com
tiptup.port=8888
tiptupMeta.type=Teamcenter Enterprise
tiptupMeta.host=tiptup.engsys.mc.xerox.com
tiptupMeta.port=7031

“Groups definitions” defines grouping of directories. In the following example, there is a special group root called root that must always be defined. The root group should contain all the directories available as long as it does impact the performance of the system.
Entry Format:
group_name“.group=”directory_list
Where group_name is a user-friendly name for a particular set of directories and directory_list a list of directories separated by semicolons ‘;’.
Example:
root.group=amberweb;pim;amberparc
cec.group=amberweb:Collection-2592;amberweb: Collection-3495

The ADML_Select service can be accessed through an HTTP GET request implementation by using the following URL format:
“http://”
host [“:”port] “/” servlets_path
“/ADML_Select?”query_string
Where:
host=<hostname as defined for URL in RFC 1738>
port=<port number as defined for URL in RFC 1738>
servlet_path=<mapped relative path to the servlet class file>
query_string=directory_spec “&” criteria_spec [&format_spec]
directory_spec=<as defined in the details section of this specification>
criteria_spec=<as defined in the details section of this specification>
Example:
   http://metaphor.xerox.com:80/servlets/ADML_Select?dir=root&cri=ttm

It can be assumed that the default user configured or the one specified in the repository-clause to access a repository has query access to all documents in the repository or at least to a subset of documents that are relevant for the search. Some constraints with the system are that Logical Names must be predefined in the ADML configuration. Furthermore, Delimiter characters, [comma (,), colon (:), at sign (@) and exclamation mark (!)] must be escaped with a backslash (\) if not used as delimiters. Because of the URL encoding required for query strings, the delimiters and escaped characters will require the following encoding:

| Intended character | URL encoding |
|---|---|
| , | %2C |
| : | %3A |
| @ | %40 |
| ! | %21 |
| \, | %5C%2C |
| \: | %5C%3A |
| \@ | %5C%40 |
| \! | %5C%21 |

The following legend summarizes some of the formatting parameters that apply to enabling the ADML service:
Spaces in definitions are only for readability. The SPC keyword will be used of there is a need to specify the need for a space character in a definition.
“literal”—Quotation marks surround literal text.
[element]—Square brackets enclose optional elements.
   |—Elements separated by a bar are alternatives, e.g., “yes”|“no” will accept “yes” or “no”.
(element1 element2)—Elements enclosed in parentheses are treated as a single element. Thus, “(elem (foo|bar) elem)” allows the token sequences “elem foo elem” and “elem”
<description>—“<” and “>” are used to enclose descriptions.
Specifying only dir=root in the directory_spec clause implies every branch in the directory, any other directory_spec will be ignored.
URL encoded—Must match the encoding defined in RFC 1738.
   Example: “docushare:Collection10” would be “docushare%3Acollection10”
logical_name is a predefined name published by PIM.
scope is system dependent, for Teamcenter Enterprise repositories it implies a Vault, for DocuShare repositories it implies a Collection.
attribute_name is a well-known attribute name published by PIM.
attribute_value is the specific criteria for the specified attribute.

The following is an example of format parameter usage:
Searches only the TTM and Lakes vaults in Teamcenter Enterprise and everywhere in Techweb for documents that contain ‘process’ in the keywords attribute.
http://metaphor/servlets/ADML_Sevlet?dir=Teamcenter Enterprise%3ATTM%2CLAKE&dir=techweb&cri=Keywords%21LIKE%21process
General Search—searches everywhere for any document containing ‘ttm’ in any attribute. http://metaphor/servlets/ADML_Select?dir=root&cri=ttm
With regard to error handling, error objects are returned in ADML_Select response through HTTP embedded in the XML data.

The ADML_Select service can be accessed through an HTTP POST request implementation as long as the parameters are specified in the same format as the GET request. The ADML_Select service responds back with XML output that contains ADML_Document object or ADML_Error. The following is an example of error handling:

Document Type Definition (DTD)

<!ELEMENT ADML_SelectResult (ADML_DocumentList|ADML_ErrorList)*>
<!ELEMENT ADML_Error_(Error_Number,Error Message)>
<!ELEMENT Error_Number (#PCDATA)>
<!ELEMENT Error_Message (#PCDATA)>
<!ELEMENT ADML_DocumentList (ADML_Document*)>
<!ELEMENT Handle (#PCDATA)>
<!ELEMENT FileName (#PCDATA)>
<!ELEMENT Description (#PCDATA)>
<!ELEMENT Version (#PCDATA)>
<!ELEMENT URL (#PCDATA)>
<!ELEMENT ADML_Document (Handle,FileName,Description,Version,URL,Master_Handle)>
<!ELEMENT Master_Handle (#PCDATA)>
<!ELEMENT ADML_ErrorList (ADML_Error*)>

The following is an XML Format Example for AMDL where One document found and no errors:

<?xml version=‘1.0’?>
<ADML_SelectResult>
<ADML_DocumentList>
<ADML_Document>
<Handle>File-25346</Handle>
<FileName> Emproc10.pdf</FileName>
<Description>Read-only Electro Mech Sub Process</Description>
<Version>1</Version>
<URL>http://techweb.wrc.xerox.com/Get/File-
25346/Emproc10.pdf</URL>
<Master_Handle>techweb:File-25346</Master_Handle>
</ADML_Document>
</ADML_DocumentList>
<ADML_ErrorList!>
</ADML_SelectResult>

The following is an example handle format for ADML:
directory “:” (id|“˜”master_id)
Where:
directory=<the information that allows ADML figure out the repository where the document is located>
id=<the system specific unique identifier>
master_id=<an unique identifier that serves as a master for a set of versions of the same document>

When a “master_id” is used in place of an “id” the ADML_Open will always look for the latest version of that document. The ADML_Open service can be accessed through an HTTP GET request by using the following URL format:
“http://” host [“:”port]“/” servlets_path “/ADML_Open?handle=” handle
Where:
host=<hostname as defined for URL in RFC 1738>
port=<port number as defined for URL in RFC 1738>
servlet_path=<mapped relative path to the servlet class file>
handle=<Value of the ADML_Document handle attribute for the intended document object. Its format is defined in specification S600.2. Must be URL encoded.>
Example:
http://adml.xerox.com:80/servlets/ADML_Open/?handle=aDSsite%3ACollection01%3AFile%2D01

The handle is specified in the XML returned by the ADML_Select. To access, for example, DocuShare documents, a URL to the DocuShare website can be used.

The implementation sample using HTTP and Servlets technology is just one of many possible ways of implementing the ADML specification. Another possible implementation could be done for embedded systems using a framework such as the Java Micro Edition Platform to enable seamless document exchange between devices such as network printers, personal digital assistants and digital phones.

The present invention is architected for scalability in such a way that it can enable a global document sharing infrastructure with a corporation's intranet or even on the extranet to share document with partners.

1. A method of implementing a neutral document management layer within a computer system adapted to operate with more than one document specification, comprising:
a abstract document management layer (ADML) service operating as a neutral document management service integrating more than one document management repository with different document definitions, wherein the ADML can be implemented in a programming language including at least one of: JAVA, C, and CORBA;
providing a normalized document definition comprising common properties of a document;
providing a mapping mechanism to map a particular document definition to the ADML service normalized document definition;
developing software and system architectures that enable document management implementation plug-ins; and
providing a network-enabled interface adapted to enable users to the single service to access, manage and manipulate documents comprised of more than one document format with the ADML service and wherein the documents are retrieved and transmitted from/to a remote source using any known data exchange protocol.

2. The method of claim 1 wherein the ADML service is accessible by user through a Web-browser using the service.

3. The method of claim 2 wherein the ADML service is made available to users through a web service using JAVA servlets, and ADML service requests are based on the HTTP protocol, wherein responses by the ADML service are based on the XML protocol.

4. The method of claim 3 wherein access to contents of the documents are based on URL's, wherein URL's allow the ADML service to download the document without additional software interaction.

5. The method of claim 4 wherein the URL's are stored outside of the ADML service and used to access a specific document.

6. A computer system adapted to operate with more than one document specification, comprising:
a abstract document management layer (ADML) service module operating as a neutral document management service integrating more than one document management repository with different document definitions, wherein the ADML can be implemented in a programming language including at least one of: JAVA, C, and CORBA;
a normalized document definition table comprising common properties of a document;
a mapping mechanism configured to map document definitions to the ADML service module normalized document definition obtained from the normalized document definition table; and
a network interface adapted to enable a user to access, manage and manipulate documents comprised of more than one document format with the computer system, wherein the documents are retrieved and transmittable from/to a remote source using any known data exchange protocol.

7. The computer system of claim 6 wherein the ADML service module is accessible by user through a Web-browser using the service.

8. The computer system of claim 7 wherein the ADML service module is made available to users through a web service using JAVA servlets, and ADML service module requests are based on the HTTP protocol, wherein responses by the ADML service module are based on the XML protocol.

9. The computer system of claim 8 wherein access to contents of documents are based on URL's, wherein URL's allow the ADML service module to download the document without additional software interaction.

10. The method of claim 9 wherein the URL's are stored outside of the ADML service module and used to access a specific document.

11. A abstract document management layer (ADML) service module operating as a neutral document management service integrating more than one document management repository with different document definitions, wherein the ADML service module can be implemented in a programming language including at least one of: JAVA, C, and CORBA, the ADML service module comprising:
access by ADML service module to normalized document definitions listed in a normalized document definition table comprising common properties of a document;
access by ADML service module to a mapping mechanism to map a particular document definition to the ADML service module normalized document definition; and
access to the ADML service module a network-enabled interface adapted to enable users to the single service to access, manage and manipulate documents comprised of more than one document format with the ADML system and wherein the documents are retrieved and transmitted from/to a remote source using any known data exchange protocol;
wherein the ADML service module is adapted for operation within a software and system architecture that enables document management implementation plug-ins through the network-enabled interface.

12. The method of claim 1 wherein the ADML service module is accessible by user through a Web-browser using the service.

13. The method of claim 2 wherein the ADML service module is made available to users through a web service using JAVA servlets, and ADML service module requests are based on the HTTP protocol, wherein responses by the ADML service module are based on the XML protocol.

14. The method of claim 3 wherein access to contents of the document are based on URL's, wherein URL's allow the ADML service module to download the document without additional software interaction.

15. The method of claim 4 wherein The URL's are stored outside of the ADML service module and used to access a specific document.
